(19) United States
(12) Patent Application Publication
(10) Pub. No.: US 2026/0240360 A1
(43) Pub. Date: Aug. 20, 2026

(54) APPARATUS FOR PREPARING HOT BEVERAGES HAVING STEAM LANCE

(71) Applicant: Franke Kaffeemaschinen AG, Aarburg (CH)

(72) Inventors: David OGGIER, Oberkirch (CH); Matteo IOANNONE, Steinmaur (CH)

(73) Assignee: Franke Kaffeemaschinen AG, Aarburg (CH)

(21) Appl. No.: 18/853,540

(22) PCT Filed: Mar. 28, 2023
(86) PCT No.: PCT/EP2023/058058

§ 371 Date: Oct. 2, 2024

(30) Foreign Application Priority Data
Apr. 25, 2022 (DE) 10 2022 109 867.2

(51) Int. Cl. A47J 31/44; A47J 31/46; A47J 31/52

(52) U.S. Cl. CPC A47J 31/4489; A47J 31/461; A47J 31/468; A47J 31/5253

(57) ABSTRACT

For a hot beverage preparation apparatus having a beverage outlet head for discharging prepared hot beverages and having a steam lance, which is separate from the beverage outlet head, for foaming milk poured into a milk vessel which, in a foaming position, can be positioned in front of the hot beverage preparation apparatus such that the steam lance dips into the milk vessel, and having at least one milk outlet which is arranged so as to interact with the steam lance and via which milk can be discharged into the milk vessel positioned in the foaming position, it is provided that the milk outlet is arranged behind the steam lance and spatially separated therefrom and ends above the free end of the steam lance in such a manner that the milk vessel, with the steam lance dipped into it in the foaming position, is positioned under the milk outlet.

### CROSS-REFERENCE TO RELATED APPLICATIONS

This application is a 371 National Phase of PCT/EP2023/058058, filed Mar. 28, 2023, which claims priority from German Patent Application No. 10 2022 109 867.2, filed Apr. 25, 2022, both of which are incorporated herein by reference as if fully set forth.

### TECHNICAL FIELD

The present invention relates to a hot beverage preparation apparatus having at least one beverage outlet head for discharging prepared hot beverages and having a steam lance, which is separate from the beverage outlet head, for foaming milk poured into a milk vessel which, in a foaming position, can be positioned in front of the hot beverage preparation apparatus in such a manner that the steam lance dips into the milk vessel, and having at least one milk outlet which is arranged so as to interact with the steam lance and via which milk can be discharged into the milk vessel positioned in the foaming position.

### BACKGROUND

Hot beverage preparation apparatuses, in particular coffee machines, are frequently equipped with an apparatus for generating milk foam in order to be able to prepare coffee beverages, such as cappuccino or latte macchiato. In addition to fully automatic coffee machines which have an internal milk system for discharging ready-foamed milk foam, what are referred to as steam lances are frequently also provided, which can discharge steam with which milk in a milk vessel can be foamed. Air which is required for foaming the milk can also be added here to the steam. A foaming apparatus with a steam lance is described, for example, in WO 2019/141409 A1.

The publication EP 2 878 241 B1 describes a coffee machine having a steam lance, in which a milk supply line also opens into the steam discharge channel, and therefore milk can firstly be discharged via the steam lance into a milk vessel positioned under the steam lance, the milk subsequently being foamed with steam.

The publication EP 3 756 516 A1 describes a milk foaming apparatus having a steam lance which, in addition to the steam discharge channel, has a second channel which is separate from the steam discharge channel and is connected to a milk supply line. Also in the case of this milk foaming apparatus, milk can thus first of all be discharged via the steam lance and subsequently foamed.

However, a disadvantage of discharging milk via the steam lance is that, because of the high temperatures reached during discharging of steam, milk residues in the interior of the steam lance, in particular in the region of the mouth of the milk supply line, may denature and cake together. Since the interior of the steam lance can be difficult to clean, this results in hygiene problems over time.

### SUMMARY

It is an object of the invention to specify a hot beverage preparation apparatus having a steam lance, in which hygiene problems of this type do not occur.

The object is achieved by a hot beverage preparation apparatus having one or more of the features described herein. Advantageous refinements can be gathered from the description and claims that follow.

In the case of a hot beverage preparation apparatus of the type mentioned at the beginning, it is provided according to the invention that the milk outlet is arranged behind the steam lance and spatially separated therefrom and ends above the free end of the steam lance in such a manner that the milk vessel, with the steam lance dipped into it in the foaming position, is positioned under the milk outlet. In this way, it is possible to position the milk vessel in the foaming position and first of all to discharge, via the milk outlet, a portioned quantity of milk into the milk vessel, the milk subsequently being foamed by a discharge of steam via the steam lance dipping into the milk vessel or into the milk poured into the latter. Since the milk outlet is arranged separately from the steam lance, said milk outlet is not heated by the hot steam, and therefore milk residues which have remained in the milk outlet cannot denature and bake on. The milk outlet can be designed, for example, as a downwardly curved discharge pipe protruding from the front of the hot beverage preparation apparatus. The discharge pipe can advantageously also be inclined forward here at an outlet angle in the direction of the steam lance such that discharged milk runs along the steam lance into the milk vessel.

Preferably, the hot beverage preparation apparatus is provided with a controller which is designed, upon activation of a foaming process, to discharge, via the milk outlet, a portioned quantity of milk into the milk vessel positioned in the foaming position. In the case of conventional coffee machines having a steam lance, the milk generally has to be poured manually into the milk vessel by the operator. This generally takes place liberally by visual judgement, which leads to very frequently too much milk being foamed and having to be subsequently thrown away. Automated portioning ensures that the quantity of milk provided for a selected beverage is always discharged and subsequently foamed such that no residues remain behind or eventually even too little milk is foamed for the desired beverage. The portioning can take place here via a flow measurement or else by specifying an activation duration of the milk pump with which the milk is conveyed to the milk outlet.

The controller can furthermore be designed, following the discharge of milk, to release a discharge of steam via the steam lance. By this means, fully automated foaming is possible, in which the operator merely positions the milk vessel in the foaming position and subsequently activates the foaming process via a corresponding user interface, for example a touchscreen. The further steps of discharging milk and the subsequent discharging of steam for the foaming process are realized in an automated manner by the controller.

In addition, a temperature sensor which is arranged so as to interact with the steam lance can preferably be provided, which temperature sensor senses, during the foaming process, the temperature of the milk poured into the milk vessel and indicates the temperature to the controller. The controller can furthermore be designed to end the discharge of steam when a desired temperature is reached. Since the milk is conveyed, for example, from a milk refrigerator with a defined starting temperature into the milk vessel, the final temperature depends on the quantity of steam and/or activation duration of the discharge of steam. Thus, not only is it possible to determine via the temperature sensor whether the milk foam has reached the desired temperature, but it can also be concluded that the desired foam consistency, which is likewise dependent on the activation duration of the discharge of steam, has been reached. The temperature sensor can be arranged in particular at the free end of the steam lance.

In a preferred development of the present invention, at the hot beverage preparation apparatus, a plurality of milk outlets, which are arranged next to one another behind the steam lance, can be provided for different types of milk. The types of milk used for a foaming process can be selected via a user interface. Thus, not only can different types of milk, such as normal full milk, lactose-free milk, low-fat milk or a vegan milk replacement product (e.g. soya milk, oat milk, coconut milk, almond milk, pea milk, etc.) be provided, but it can additionally be ensured via the separate milk outlets that mixing of different types of milk due to milk residues which have remained in the milk line from the previous discharge of milk is avoided. This is in particular a great advantage in order to be able to provide strictly vegan products, and for customers/consumers with food allergies or incompatibilities with certain types of milk or milk constituents.

Within the scope of the invention, it can also be provided that an air supply line via which air for foaming the milk is supplied to the steam opens into the steam lance. By means of a controlled supply of air, the foaming of the milk is improved and it is reproducibly ensured that the same milk foam consistency is always obtained during each foaming process. In particular, it can be provided that air is added to the steam in a first phase during the foaming and the supply of air is closed in a second phase such that only steam is discharged, with which the milk foam is further refined and the consistency improved.

Air can be supplied in a manner known per se via an air valve with the aid of the Venturi effect. Preferably, however, an air pump (compressor) which supplies air under positive pressure for foaming the milk is arranged in the air supply line. The use of an air pump permits good metering of the quantity of air, and the supply of the pressurized air improves the foaming process.

In a preferred development of the invention, it can be provided that the steam lance is arranged on the beverage preparation apparatus so as to be pivotable in the vertical direction via a joint. This simplifies the positioning of the milk vessel by the steam lance being able to be pivoted from above into the milk vessel or pivoted downward together with the setting down of the milk vessel. In particular when using correspondingly tall milk vessels, by which splashing of milk is prevented, it can therefore be achieved that the steam lance projects sufficiently far into the milk vessel such that the free end of the steam lance dips sufficiently far into the poured-in milk.

In a preferred embodiment, it can be provided that a milk line leading to the milk outlet is connectable to the beverage outlet head of the hot beverage preparation apparatus switchably via a valve arrangement in order selectively to discharge milk into a drinking vessel positioned under the outlet head or into a milk vessel positioned in the foaming position. Thus, both the discharging of a milk-containing beverage via the outlet head and separate foaming of milk and subsequent manual addition of the milk foam to the hot beverage discharged via the outlet head are possible.

Furthermore, it can be provided that an inlet of the milk line is connectable via a switching valve to a milk pump selectively via a continuous flow heater or a bypass line bypassing the continuous flow heater. Therefore, it is selectively possible to discharge heated milk via the continuous flow heater or cold milk via the bypass line. Discharging of heated milk is advantageous if the milk is supplied directly to a hot beverage via the beverage outlet head. By contrast, the discharging of cooled milk via the bypass line is advantageous if the milk is discharged into the milk vessel via the milk outlet for foaming, since better foaming results are obtained with cold milk.

Furthermore, it can preferably be provided that an air valve opens into a fluid line connected to the suction side of the milk pump and a throttle element is arranged in a fluid line connected to the pressure side of the pump. By means of a controlled supply of air on the suction side of the milk pump and the increase in pressure brought about by the throttle element in the pump, milk foam is already produced in the milk pump. Said milk foam can subsequently be discharged via the beverage outlet head directly or via a continuous flow heater. If, by contrast, milk is discharged via the milk outlet into a milk vessel for separate foaming of the milk, the air valve is closed such that the milk is not foamed in the milk pump and therefore unfoamed milk emerges from the milk outlet. In this way, it is possible selectively for milk foam to be discharged to the outlet head (one-step mixed beverages) or for the milk to be foamed separately via the steam lance and subsequently added to a hot beverage discharged via the outlet head (two-step mixed beverage).

### BRIEF DESCRIPTION OF THE DRAWINGS

Further advantages and refinements of the invention emerge from the description below of an exemplary embodiment with reference to the figures, in which:

FIG. 1 shows a front view of a coffee machine in the form of a countertop device with two coffee preparation units and a central foaming unit,

FIG. 2 shows a detailed view of the foaming unit from FIG. 1,

FIG. 3 shows what is referred to as a water flow diagram of the milk paths in the foaming unit from FIG. 2, and

FIG. 4 shows an exemplary embodiment of a foaming unit with a milk outlet inclined in the direction of the steam lance.

### DETAILED DESCRIPTION

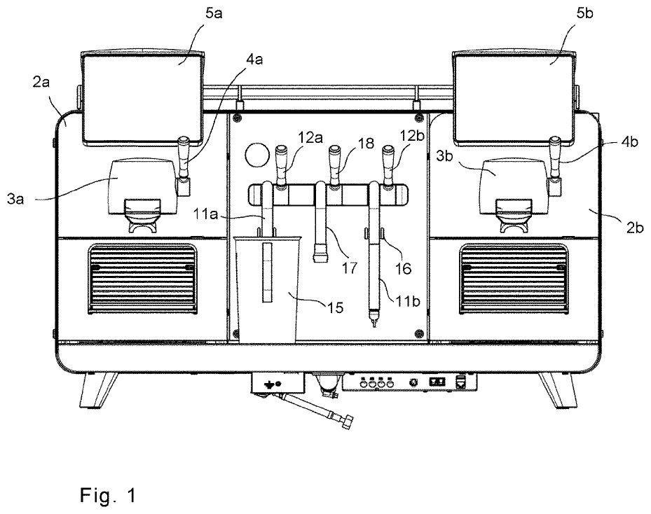

The coffee machine 1 shown in FIG. 1 is a countertop device with two coffee preparation units 2a and 2b which are respectively arranged on the left and right of the coffee machine 1. A milk foaming unit 10 is located centrally between the two coffee preparation units 2a, 2b.

The coffee preparation units 2a, 2b are constructed in the manner of a fully automatic coffee machine of a design known per se with a water heater, brewing assembly and grinding unit. The precise design does not need to be discussed further here. The outlet head 3a, 3b, via which freshly brewed coffee beverages are discharged, is seen in the center of the respective coffee preparation units 2a, 2b in FIG. 1. An operating lever 4a, 4b arranged at the side of the outlet head 3a, 3b serves for influencing a brewing parameter, such as the pressure or the flow rate during a brewing process. A graphical user interface in the form of a touchscreen 5a, 5b is arranged in each case in the upper region of the two coffee preparation units 2a, 2b. A beverage selection can be made and a brewing process or beverage preparation process started via said touchscreen. In a manner likewise known per se, the beverage preparation can also comprise discharging milk or milk foam via the outlet head 3a, 3b. For this purpose, the coffee machine 1 is connected to a milk refrigerator, not illustrated in FIG. 1, which comprises a plurality of milk containers from which milk can be conveyed by means of a milk pump. A milk refrigerator usable with the coffee machine is described in WO 2021/074038 A1, to which reference is hereby made in full in order to avoid unnecessary repetitions.

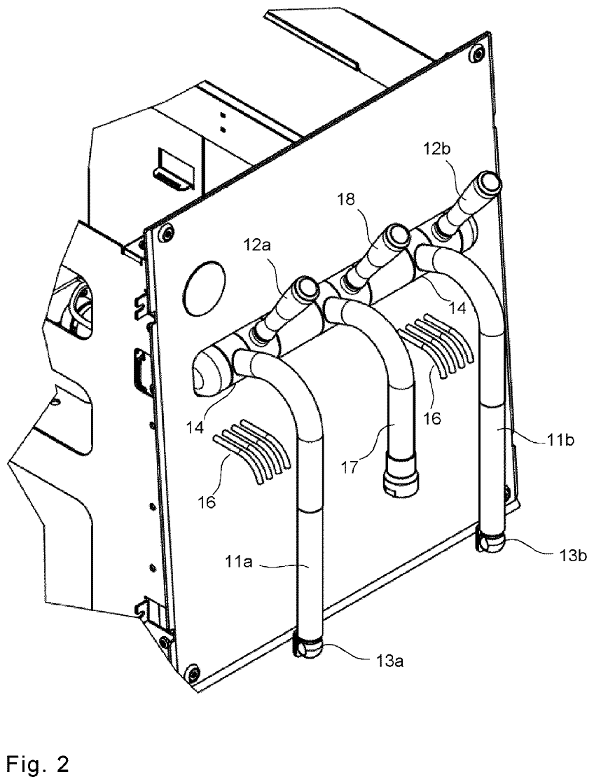

Of interest within the scope of the present invention is in particular the central module of the coffee machine 1, the foaming unit 10, the front portion of which is illustrated in more detail in FIG. 2. The foaming unit serves for manually or separately foaming milk in a foaming vessel 15, for example a milk jug or a tall glass beaker. For this purpose, the foaming unit 10 has two steam lances 11a, 11b (a steam lance is frequently also referred to as a steam pipe) via which, by actuation of an associated operating lever 12a, 12b, steam or steam mixed with air can be discharged for foaming milk located in the foaming vessel 15. A foaming nozzle 13a, 13b is located in each case at the free end of the steam lance 11a, 11b. The steam lances 11a, 11b are each coupled to the front panel of the foaming unit 10 via a pivoting joint 14a, 14b such that they can be pivoted downward from above into the foaming vessel 15 located in its foaming position. In each case four milk outlets 16, via which different types of milk can be discharged into the foaming vessel 15, are located behind the two steam lances 11a, 11b. Located between the two steam lances 11a, 11b is a hot water discharge pipe 17 with an associated actuating lever 18, via which hot water can be discharged for preheating cups or for preparing tea or other beverages.

The discharging of milk via the milk outlets 16 and a subsequent foaming process can be controlled via the graphical user interfaces 5a, 5b of the coffee machine 1, wherein expediently the left touchscreen 5a is assigned in terms of control to the left steam lance 11a and the right touchscreen 5b is assigned in terms of control to the right steam lance 11b.

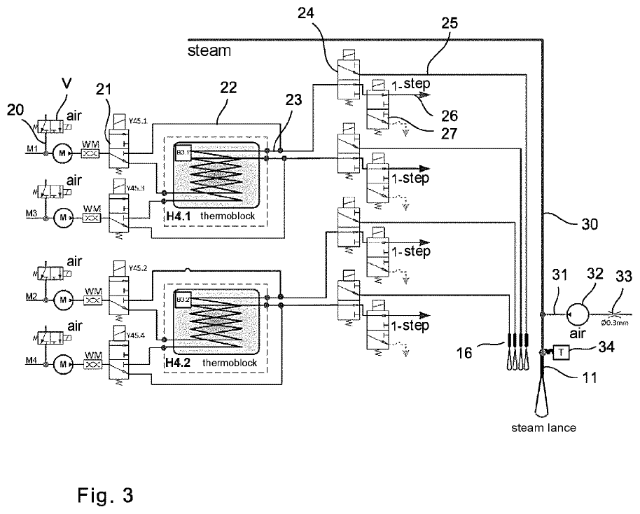

The course of the milk lines to and in the foaming unit 10 is shown in the water flow diagram illustrated in FIG. 3. The water flow diagram shows four milk suction lines M1, M2, M3, M4 which are connected to four milk containers in the milk refrigerator (not shown). The milk paths from the suction lines to the associated milk outlet 16 are basically constructed identically, and therefore the design is described here by way of example only by way of the upper milk path.

An air supply line 20, which is provided with an air valve V, opens in each case into each of the suction lines M1 to M4. The air valve V can be closed or opened in order to shut off or release the supply of air. In order to supply a defined quantity of air, the air valve V can also be operated in pulsed form, i.e. intermittently, with the quantity of air being able to be metered via the pulse frequency and/or the duty cycle. The milk suction lines M1 to M4 are in each case connected to the suction side of a milk pump M. On the output side, the milk pumps M are each connected to a throttle element WM in the form of a fixed panel or, as here, to a helical mixer which serves as a pressure-increasing element. A switching valve 21 in the form of a 3/2-way valve is in each case located behind the throttle element WM. The switching valve 21 serves to conduct the milk flow either via a continuous flow heater in the form of a thermoblock H4 or a bypass line 22 bypassing the thermoblock H4 in the direction of the associated milk outlet 16. A total of two thermoblocks H4.1, H4.2 which each have two separate fluid paths are provided for the four parallel milk lines. A continuous flow heater of this type is described in DE 20 2021 101 017 U1, to which reference is hereby made in full in order to avoid unnecessary repetitions.

Behind the continuous flow heater H4, the bypass line 22 and the flow path 23 leading through the continuous flow heater converge again and lead to a further switching valve in the form of a 3/2-way valve 24. Via the switching valve 24, the milk flow can be switched between the milk outlet 16 and a direct discharge via the outlet head 3a or 3b of the coffee machine. Therefore, the milk can be guided either via the line 25 to the associated milk outlet 16 or, by switching of the valve 24, the milk flow can be guided via an outlet line 26 leading to the outlet head 3a or 3b. A drainage valve 27 is additionally also arranged in the outlet line 26, via which drainage valve the milk line can be connected directly to an outlet for emptying and for carrying out a rinsing process.

FIG. 3 additionally shows the steam line 30 which leads to the steam lance 11. The steam line 30 is connected to a steam generator, not illustrated in the figure, in the form of a pressure boiler or a continuous flow heater for steam. An air supply line 31 which is connected to an air pump 32 opens into the steam line 30. On the inlet side, the air pump 32 is connected to an air suction opening via a panel 33. By operation of the air pump 32, air can thus be supplied in a targeted manner to the steam in the steam line 30. In addition, a temperature sensor 34 is connected to the steam lance 11, the temperature sensor dipping together with the steam lance 11 into a foaming vessel 15 positioned below the latter and measuring the temperature of milk located therein during the foaming process.

The circuit shown in FIG. 3 is present twice in the coffee machine 1, in each case once for each of the steam lances 11a, 11b and the associated milk outlets 16 arranged behind them. The components shown in FIG. 3 are activated via a control unit of the coffee machine 1 and the associated user interface 5a or 5b. If a coffee beverage with milk foam is intended to be discharged, for example, via the outlet head 3a, in order to produce the milk foam, the milk pump associated with the type of milk (M1 to M4) selected via the touchscreen 5a is set into operation and air is supplied on the suction side of the pump M via the air valve V. The valve 21 is switched into the lower switching position such that the milk flow is conducted through the thermoblock H4. The valve 24 is likewise switched into the lower switching position such that milk foam is discharged at the outlet head 3a via the line 26. The drainage valve 27 is now in the upper switching position.

If, by contrast, milk foam is intended to be produced separately in the foaming vessel 15, milk is likewise conveyed via the associated milk pump M. The valve 21 is switched into the upper switching position such that the milk flow is conducted via the bypass line 22. The valve 24 is switched into the upper switching position such that the milk flow is conducted via the milk line 25 to the associated milk outlet 16 and is discharged into a foaming vessel 15 placed below it. Subsequently, steam is discharged via the steam line 30 and the steam lance 11a connected thereto and air is supplied to the steam via the air pump 32 such that the milk in the foaming vessel 15 placed therebelow is foamed. If the milk temperature which is measured via the temperature sensor 34 at the end of the steam lance 11a reaches a desired value, e.g. 50° C., this signals that the milk is fully foamed and the discharge of steam is ended.

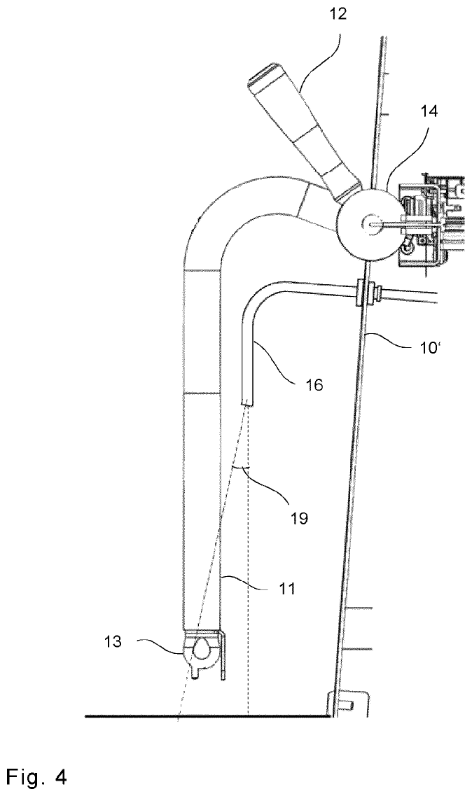

FIG. 4 shows a modified exemplary embodiment in which the milk outlet 16 is designed as a downwardly curved discharge pipe protruding from the front 10′ of the foaming unit 10, wherein the discharge pipe is inclined forward at an outlet angle 19 in the direction of the steam lance 11 such that discharged milk runs along the steam lance 11 into a milk vessel positioned therebelow. The circumferential region of the steam lance 11 facing toward the front can also be flattened here or slightly concave in order to better guide the milk flow along its outer side. The outlet angle can be, for example, between 10° and 20° in relation to the vertical. The steam lance 11 is pivotable, as previously, in the vertical direction via the joint 14 and has a foaming nozzle 13 at its free end. By actuation of the operating lever 12, steam or steam mixed with air can be discharged for foaming milk located in the foaming vessel 15.

1. A hot beverage preparation apparatus (1), comprising:
a beverage outlet head (3a, 3b) for discharging prepared hot beverages;
a steam lance (11; 11a, 11b), which is separate from the beverage outlet head (3a, 3b), for foaming milk or milk replacement product poured into a milk vessel (15), wherein, in a foaming position, the milk vessel (15) is adapted to be positioned in front of the hot beverage preparation apparatus (1) such that the steam lance (11; 11a, 11b) dips into the milk vessel (15);
at least one milk outlet (16) which is arranged so as to interact with the steam lance (11; 11a, 11b) and via which the milk or milk replacement product is adapted to be discharged into the milk vessel (15) positioned in the foaming position; and
the milk outlet (16) is arranged behind the steam lance (11; 11a, 11b) and spatially separated therefrom and ends above a free end of the steam lance (11; 11a, 11b) such a manner that the milk vessel (15), with the steam lance (11; 11a, 11b) dipped into it in the foaming position, is positioned under the milk outlet (16).

2. The hot beverage preparation apparatus (1) as claimed in claim 1, further comprising a controller which is configured, upon activation of a foaming process, to discharge, via the milk outlet (16), a portioned quantity of the milk or milk replacement product into the milk vessel (15) positioned in the foaming position.

3. The hot beverage preparation apparatus (1) as claimed in claim 2, wherein the controller is further configured, following the discharge of milk, to release a discharge of steam via the steam lance (11; 11a, 11b).

4. The hot beverage preparation apparatus (1) as claimed in claim 2, further comprising a temperature sensor (34) which is arranged so as to interact with the steam lance (11; 11a, 11b), that is configured to sense, during the foaming process, a temperature of the milk or milk replacement product poured into the milk vessel (15) and indicate the temperature to the controller, the controller being further configured to end the discharge of steam when a desired temperature is reached.

5. The hot beverage preparation apparatus (1) as claimed in claim 1, wherein the at least one milk outlet comprises a plurality of milk outlets (16), which are arranged next to one another behind the steam lance (11; 11a, 11b), for different types of milk, and the different types of milk used for the foaming process are selectable via a user interface (5a, 5b).

6. The hot beverage preparation apparatus (1) as claimed in claim 1, further comprising an air supply line (31) via which air for foaming the milk or milk replacement product is supplied to the steam opens into the steam lance (11; 11a, 11b).

7. The hot beverage preparation apparatus (1) as claimed in claim 6, further comprising an air pump (32), which supplies air under positive pressure for foaming the milk or milk replacement product, arranged in the air supply line (31).

8. The hot beverage preparation apparatus (1) as claimed in claim 1, wherein the steam lance (11; 11a, 11b) is arranged on the hot beverage preparation apparatus (1) so as to be pivotable in a vertical direction via a joint (14).

9. The hot beverage preparation apparatus (1) as claimed in claim 1, further comprising a milk line (22, 23) leading to the milk outlet (16) being switchably connected to the beverage outlet head (3a, 3b) via a valve arrangement (24) in order selectively to discharge the milk or milk replacement product into a drinking vessel positioned under the outlet head (3a, 3b).

10. The hot beverage preparation apparatus (1) as claimed in claim 9, wherein an inlet of the milk line (22, 23) is connectable via a switching valve (21) to a milk pump (M) selectively via a continuous flow heater (H4.1, H4.2) or a bypass line (22) bypassing the continuous flow heater (H4.1, H4.2).

11. The hot beverage preparation apparatus (1) as claimed in claim 10, further comprising an air valve (V) that opens into a fluid line (M1-M4) connected to a suction side of the milk pump (M) and a throttle element (WM) arranged in a fluid line connected to a pressure side of the milk pump (M).

12. The hot beverage preparation apparatus (1) as claimed in claim 11, wherein the air valve (V) is activatable such that it is switched into a closed state for a foaming process by the steam lance (11; 11a, 11b), while it is switched at least temporarily into an open state for discharging the foamed milk or milk replacement product via the outlet head (3a, 3b).

13. The hot beverage preparation apparatus (1) as claimed in claim 1, wherein the milk outlet (16) comprises a downwardly curved discharge pipe which protrudes from a front (10′) of the hot beverage preparation apparatus (1).

14. The hot beverage preparation apparatus (1) as claimed in claim 13, wherein the discharge pipe is inclined forward at an outlet angle (19) in a direction of the steam lance (11) such that discharged milk runs along the steam lance into the milk vessel (15) positioned therebelow.
